(19) United States
(12) Patent Application Publication
(10) Pub. No.: US 2010/0061919 A1
(43) Pub. Date: Mar. 11, 2010

(54) PRODUCTION OF POLYALUMINUM CHLORIDE FROM BASIC ALUMINUM CHLORIDE AND SODIUM ALUMINATE VIA ULTRASONIC PROCESSING

(76) Inventors: LEVI JAMES GROVE, Bethlehem, PA (US); Kevin Edward Janak, Ossining, NY (US)

Correspondence Address: ARTHUR J. PLANTAMURA, ESQ.;GENERAL CHEMICAL PERFORMANCE PRODUCTS LLC., 90 EAST HALSEY ROAD, PARSIPPANY, NJ, 07054, US

(21) Appl. No.: 12/207,665

(22) Filed: Sep. 10, 2008

(51) Int. Cl. C01F 7/56; C01B 17/45; B01J 19/10

(52) U.S. Cl. 423/467; 423/495; 204/157.42

(57) ABSTRACT

A method is provided for the production of a stable mid- and high-basicity polyaluminum chloride and polyaluminum chlorosulfate, respectively from sodium aluminate and aluminum chloride or low- or mid-basicity polyaluminum chloride by ultrasonic processing of the reactants. The method overcomes the formation of gels and insoluble precipitates that typically form when mixing sodium aluminate and aluminum chloride and the formation of sodium chloride, which is insoluble in high concentration polyaluminum chloride solutions. The invention eliminates the cumbersome extended heating periods previously required to deal with the formation of insoluble aluminum oxide precipitates in batches of polyaluminum chloride produced from sodium aluminate and aluminum chloride using high-shear mixing. Also because the use of ultrasonic processing reduces the amount of aluminum oxide generated, a batch heating cycle is avoided which reduces the energy costs associated with the production of polyaluminum chloride and thereby allows the process to be run as a continuous process rather than a batch process.

### FIELD OF THE INVENTION

This invention relates to an improved process for the preparation of polyaluminum chloride (PAC) and polyaluminum chlorosulfate (PACS). More particularly, the invention relates to the production of solutions of elevated basicity polyaluminum chloride from sodium aluminate and aluminum chloride or from low- or mid-basicity polyaluminum chloride or chlorosulfate utilizing ultrasonic processors that is substantially free of gel and precipitate.

### BACKGROUND OF THE INVENTION

Ultrasonic processing leads to high energy chemical reactions, occurring from the exposure of solutions or slurries to high intensity sound which leads to acoustic cavitation. Acoustic cavitation involves three steps: formation, growth and implosive collapse of bubbles. The implosive collapse of cavitation bubbles leads to areas of very high temperature (5000K) and pressure (1000 atm). Ultimately, the extraordinary temperatures and pressures associated with acoustic cavitation provides routes to reaction pathways that differ from traditional high temperature, high pressure reactions. (See Suslick, Kenneth. S.; “Sonochemistry.” Kirk-Othmer Encyclopedia of Chemical Technology. 4th ed. 1998.) Aluminum containing inorganic reagents such as alum (Al₂(SO₄)₃), polyaluminum hydroxychlorides (PAC), and polyaluminum hydroxychlorosulfates (PACS) are commonly used as flocculents and coagulants in municipal and industrial water and wastewater treatment. Although typically more expensive to manufacture than alum, PAC and PACS products are frequently found to work better than alum with regard to floc settling rates, cold water performance, and water pH adjustment. PAC and PACS products are typically described by the empirical formula:

Alₙ(OH)₃ₙ₋ₘ₋₂ₖ(SO₄)ₖClₘ

where n is the moles of aluminum, k is the moles of sulfate, and m is the moles of chloride in the product. The corresponding basicity of the product is defined as % Basicity={[OH⁻]/(3[Al³+])}×100, with the basicity calculated as the ratio [(3n−m−2k)/3n]×100. When an alkali metal base or an alkali earth metal base is used to adjust the final basicity of the PAC or PACS product, the empirical formula of the product can be amended in the following manner:

Alₙ(OH)_{3n+Zx-m-2k}(SO₄)ₖClₘYₓ,

where n is the moles of aluminum, k is the moles of sulfate, m is the moles of chloride, x is the moles of alkali metal or alkali earth metal and Z is the valence of the metal (e.g., 1 for Na⁺ and 2 for Ca²⁺). The basicity of the product is typically adjusted in order to account for desired stability, performance, and/or other product characteristics, with the basicity calculated as the ratio [(3n+Zx−m−2k)/3n]×100. In addition, PAC and PACS products are characterized by aluminum and aluminum sulfate polymers consisting of wide degrees of polymerization, with reported values ranging from the ˜1,000 Dalton Al₁₃-mer Keggin-type complex (see, for example, U.S. Pat. Nos. 5,985,234 and 5,997,838) to average molecular weight values of 7,000-35,000 Daltons, as described in U.S. Pat. No. 5,171,453. A variety of processes have been reported describing methods for producing PAC and PACS chemical reagents for water treatment applications. For example, the above noted U.S. Pat. Nos. 5,985,234 and 5,997,838 describe a process whereby aluminum oxide trihydrate is reacted with hydrochloric acid and sulfuric acid at elevated temperature (115° C.) to form a polyaluminum hydroxychlorosulfate product which can be subsequently reacted with sodium aluminate under high shear mixing (˜1,000 Hz) at temperatures below 60° C. to produce a PACS of 50%-70% basicity and, at temperatures above 60° C., products of greater than 70% basicity. The high shear mixing involved in the process is a necessary component of the reaction. Additionally, this process suffers from the disadvantage resulting from the presence of appreciable aluminum oxide gel precipitates in the milky product which requires a batch heating cycle to redissolve the precipitates and form a clear solution. Further, it is described that the formation of significant amounts of smaller aluminum polymers, specifically the Al₁₃-mer Keggin complex, is an important component to the performance of the product. The requirement of high shear mixing is also mentioned in U.S. Pat. No. 4,877,597. The process involves the addition of an alkali metal aluminate to alum between 10° C.-35° C., followed by warming the reaction to 50° C.-90° C. This results in a PACS product with 7%-10% Al₂O₃, albeit with significant amounts of sodium sulfate by-product.

In addition, U.S. Pat. No. 5,603,912 describes a method of making a 50%-73% basicity PACS via an initial high temperature reaction of aluminum and aluminum chloride or hydrochloric acid, followed by reaction with sulfuric acid and then an alkaline earth carbonate such as calcium carbonate. Important features of the process of that patent include: i) the need to adjust the Al/Cl atomic ratio to 0.70-1.2 prior to sulfate ion addition, ii) initial preparation of the PACS at high temperature, and iii) addition of an alkaline earth carbonate (e.g., CaCO₃) at 45° C. Similarly, U.S. Pat. No. 5,246,686 discloses a process whereby an aluminum hydroxychlorosulfate is reacted with an alkaline earth carbonate, although at temperatures ranging from 60° C.-100° C., to produce polyaluminum hydroxychlorosulfates with basicities in the range of 45%-70%. However, it is reported that the process results in the undesirable formation of insoluble gypsum

A method that avoids the formation of gypsum and other alkaline earth sulfates is described in U.S. Pat. No. 5,348,721, requiring the initial production of a PACS of 40%-50% basicity at elevated temperature (140° C.) and pressure (2 bar), which is subsequently reacted with an alkaline metal carbonate (e.g., Na₂CO₃) or alkaline earth carbonate (e.g., CaCO₃) at temperatures in the range of 50° C.-70° C. to form PACS of 65%-75% basicity. Significantly, reaction with the selected base at lower temperatures (e.g., 40° C.), results in a product that is unstable with respect to the formation of a gel

A low temperature process for the preparation of PACS is reported in U.S. Pat. No. 5,124,139 whereby aluminum trichloride is blended with alum at temperatures between 35° C.-50° C., followed by addition of a calcium base such as calcium carbonate, calcium oxide, or calcium hydroxide. However, in contrast to the process of the present invention, products above 60% basicity made via the process of that patent are unstable and tend to solidify. In addition, reaction mixtures containing amounts of AlCl₃ and Al₂(SO₄)₃ such that initially prepared solutions with Al₂O₃ contents greater than 8.5% were reported to solidify even prior to addition of base. Moreover, it is not apparent that a product made via the method of that patent can contain concentrations of aluminum greater than 10% Al₂O₃

None of the known prior art methods is regarded as providing a solution product which: utilizes the low cost raw material, sodium aluminate and is substantially free of, and, more importantly, remains stable with respect to the formation of gel and objectionable precipitates and which can be produced utilizing a continuous process.

### SUMMARY OF THE INVENTION

The invention provides a method for the production of mid- and high-basicity polyaluminum chloride or chlorosulfate from sodium aluminate and aluminum chloride or low- or mid-basicity polyaluminum chloride or chlorosulfate. The invention by utilizing ultrasonic processing overcomes substantially permanently the formation of gels and insoluble precipitates that typically form when mixing sodium aluminate and basic aluminum chloride.

The method of the invention introduces a relatively marked improvement in reducing the formation of aluminum oxide precipitates compared to results achieved by high shear mixing. In an attempt to avoid the formation of insoluble aluminum oxide precipitates, the prior art requires that batches of polyaluminum chloride produced from sodium aluminate and basic aluminum chloride or chlorosulfate prepared by using high-shear mixing and heating that these treatments must be applied for an extended period of time to redissolve the aluminum oxide precipitates. The use of ultrasonic processing according to the method of the invention substantially reduces the amount of aluminum oxide precipitates formed thereby precluding the need to use a batch heating cycle, thereby substantially reducing the energy costs associated with the production of polyaluminum chloride and permits the process according to the invention to be run as a continuous process rather than a batch process.

As used herein, in reference to composition basicity; low basiscity refers to a basicity of less than about 33%; mid-basicity to a basicity of between about 34% and 66%; and high-basicity as having a basicity in excess of about 66%. Ultrasonic processing refers to a treatment wherein a solution or slurry is pumped through a chamber and subjected to high frequency sound waves (of the order of ˜24 kHz). The sonotrode is the portion of the ultrasonic processor which transmits the high frequency sound waves into the liquid or slurry being processed.

The term polyaluminum chloride and polyaluminum chlorosulfate as used herein are synonomous, respectively, with polyaluminum hydroxychloride and polyaluminum hydroxychlorosulfate.

The term production of elevated basicity as used herein refers to the conversion of a lower basicity to a higher to a high basicity e.g., the conversion of aluminum chloride to a mid or high basicity as well as to the conversion of a lower basicity polyaluminum chloride to a higher basicity product.

### BRIEF DESCRIPTION OF THE FIGURES

FIG. 1 is a flow diagram illustrating a continuous method according to the invention for the production of polyaluminum chloride using sodium aluminate and basic aluminum chloride.

FIG. 2 is the ²⁷Al NMR spectrum of the product of example 4.

### DETAILED DESCRIPTION OF THE INVENTION

The method of the invention provides for the production of mid- and high-basicity polyaluminum chloride from sodium aluminate and aluminum chloride or low-basicity polyaluminum chloride. The invention applying ultrasonic processing overcomes the drawbacks of known prior methods by substantially reducing the formation of gels and of insoluble precipitates that typically form when mixing sodium aluminate and aluminum chloride, as well as avoiding the formation of sodium chloride, which is insoluble in high concentration polyaluminum chloride solutions.

The practical importance of the invention lies in the ability to utilize sodium aluminate, which is a cost-effective basic aluminum source, for the production of mid- and high-basicity polyaluminum chloride and polyaluminum chlorosulfate products.

The invention also obviates the time consuming need to heat batches of product for extended periods in efforts to redissolve the aluminum oxide precipitates that are formed by known procedures.

The process of the invention will be described further by reference to the following specific examples intended as illustrative but not limiting. Quantities specified are by weight unless otherwise stated.

### EXAMPLE 1

A 2 L flask was charged with 2.5 kg AlCl₃ solution (10.45% Al₂O₃, 19.85% Cl). This solution was recirculated through a Hielscher UIP1000 flow cell at a pressure of 15 PSIG. The ultrasonic processor was providing 400 watts of power through a 34 mm sonotrode. Then, over the course of 1.5 hours, 40 mL of 45% sodium aluminate solution (25.94% Al₂O₃, 19.85% Na₂O) was pumped into the system just prior to entering the ultrasonic processor flow cell. The resulting yellow solution was filtered and yielded the following analysis: 12.75% Al₂O₃, 18.58% Cl, 49.8% basicity.

### EXAMPLE 2

A 2 L flask was charged with 1.0 kg basic aluminum chloride (14.66% Al₂O₃, 18.22% Cl), 167 g alum and 448 g of water. This solution was recirculated through a Hielscher UIP1000 ultrasoiic processor flow cell at a pressure of 20 PSIG. The ultrasonic processor was providing 450 watts of power through a 34 mm sonotrode. Over the course of 45 minutes, 345 g of 45% sodium aluminate was pumped into the system just prior to entering the ultrasonic processor flow cell. After the addition of water, the solution had the following analysis: 9.53% Al₂O₃, 8.19% Cl, 2.19% Na, 1.61% SO₄²⁻, 74.3% basicity.

### EXAMPLE 3

A 4 L flask was charged with 2.0 kg of basic aluminum chloride (15.3% Al₂O₃, 24.82% Cl) and 675 g of low basicity polyaluminum chlorosulfate (5.46% Al₂O₃, 1.43% Cl, 11.34% SO₄²⁻). This solution was recirculated tlrough a Hielscher UIP1000 ultrasonic processor flow cell at a pressure of 20 PSIG. The ultrasonic processor was providing 400 watts of power through a 34 mm sonotrode. Over the course of 35 minutes 398 g of 45% sodium aluminate solution was pumped into the system just prior to entering the ultrasonic processor flow cell. Then 996 g of 13% soda ash solution was pumped into the system just prior to ultrasonic processing. During the soda ash addition ultrasonic processing power was reduced to 150 watts. The resulting solution had the following analysis: 10.9% Al₂O₃, 12.4% Cl, 1.85% SO₄²⁻, 3.46% Na.

### EXAMPLE 4

In a continuous processing, a 25 gallon tank was charged with 89.9 lbs. of mid-basicity polyaluminum chloride (16.88% Al₂O₃, 20.47% Cl), 50.5 lbs. of water and 18.3 lbs. of liquid alum. This mixture was stirred for twenty minutes to yield a homogeneous mid-basicity polyaluminum chlorosulfate solution. This solution was then pumped through a Hielscher UIP1000 ultrasonic processor flow cell with a variable speed progressive cavity pump at a rate of 1.4 gallons per minute. Concurrently, a sodium aluminate solution (11.52% Al₂O₃, 7.00% Na) was pumped into the system just prior to ultrasonic processing at a rate of 0.13 gallons per minute. The pressure at the outlet of the ultrasonic processor flow cell was 10 PSIG. The ultrasonic processing power provided was 550 watts. The resulting solution was then pumped through a Hielscher UIP1000 ultrasonic processor flow cell with a variable speed progressive cavity pump at a rate of 1.25 gallons per minute. Concurrently, a sodium aluminate solution (11.52% Al₂O₃, 7.00% Na) was pumped into the system just prior to ultrasonic processing at a rate of 0.25 gallons per minute. The pressure at the outlet of the ultrasonic processor flow cell was 10 PSIG. The ultrasonic processing power provided was 550 watts. The resulting solution was then pumped through a Hielscher UIP1000 ultrasonic processor flow cell with a variable speed progressive cavity pump at a rate of 1.38 gallons per minute. Concurrently, a sodium aluminate solution (11.52% Al₂O₃, 7.00% Na) was pumped into the system just prior to ultrasonic processing at a rate of 0.12 gallons per minute. The pressure at the outlet of the ultrasonic processor flow cell was 10 PSIG. The ultrasonic processing power provided was 550 watts. The resulting solution had a turbidity of 133 NTU. The filtered product solution contained 10.8% Al₂O₃, 1.77% Na, 2.07% SO₄²⁻, 9.12% Cl and 75.4% basicity

The advantages offered by the system of the invention wherein ultrasonic processing reduces the amount of aluminum oxide precipitates fonned and eliminates the need for a heating cycle. This notably reduces the energy costs associated with the production of polyaluminum chloride but also allows the process to be run as a continuous process rather than a batch process

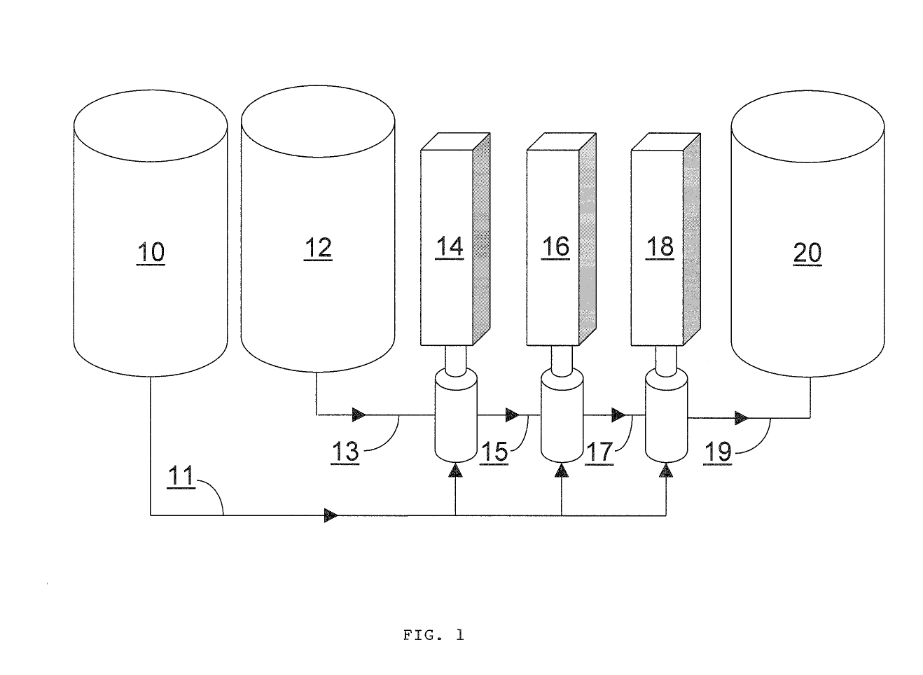

A description of the invention as applied to continuous process is provided by reference to the flow diagram of FIG. 1 of the drawing.

In the flow diagram, aluminum chloride, low- or mid-basicity polyaluminum chloride or chlorosulfate is combined with sodium aluminum solution inside an ultrasonic processor flow cell. In order to avoid the formation of undesirable precipitates and enhance stability against the formation of precipitates it may be necessary to add the sodium aluminate solution in portions with multiple ultrasonic processors in series to achieve the desired high-basicity product. Referring to FIG. 1 the aluminum chloride, low- or mid-basicity polyaluminum chloride or polyaluminum chlorosulfate from source 10 is pumped via line 11 into an ultrasonic processor flow cell 14 in admixture with a sodium aluminate solution source 12 via line 13. The ultrasonic exposure results in the formation of the conversion to an elevated mid- or high-basicity polyaluminum chloride or chlorosulfate solution i.e., the conversion to a product with a basicity greater than that of the initial solution. The resulting solution from cell 14 is then pumped into one or more subsequent ultrasonic processor flow cell or cells 16 and 18 along with additional sodium aluminate solution via line 11 to yield a product solution at 20 with the desired elevated higher basicity. While a single ultrasonic processor may be used, to facilitate processing of the mixture, a plurality of ultrasonic processing the mixture in multiple steps to prevent the formation of precipitates and gels is preferable.

The ultrasonic processing of the admixture of the invention may very widely, i.e., from about 30 minutes to 12 hours. However, it will be understood that in some instances the ultrasonic processing period may be even longer. The length of the processing time will depend on the temperature of the solution, the target basicity of the final product and ratio of sodium aluminate to low basicity polyaluminum chloride or chlorosulfate and the size of the batch.

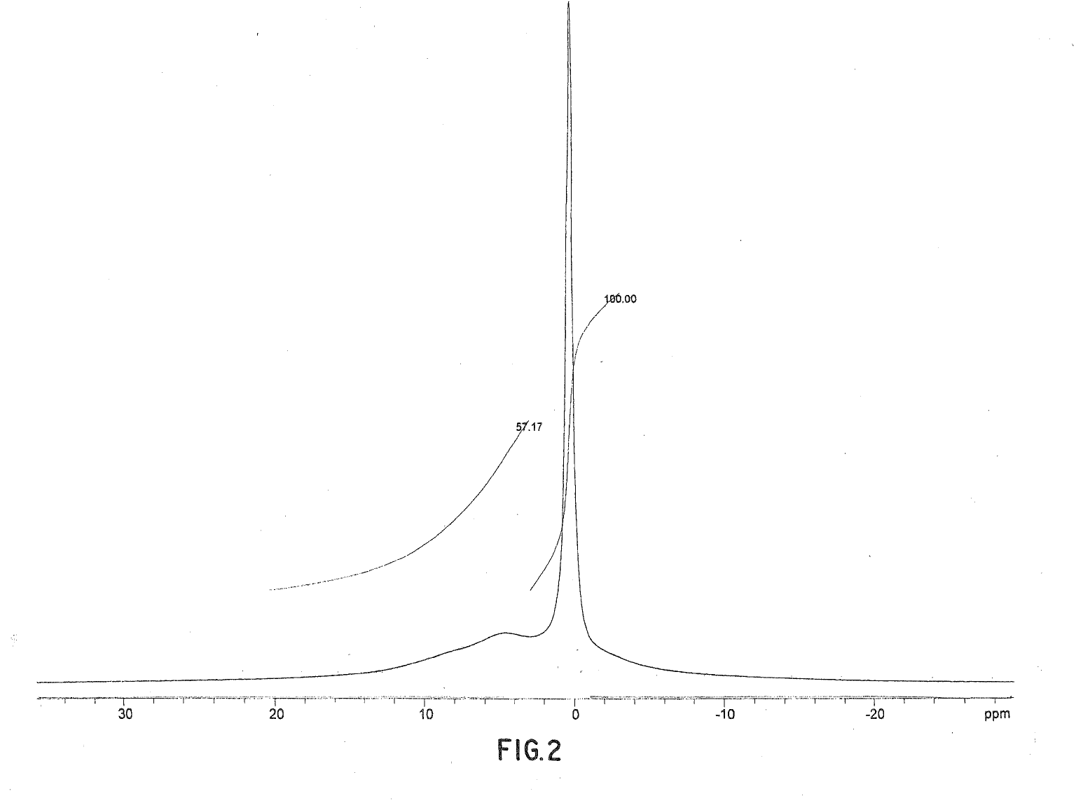

The ²⁷Al NMR spectrum of the product resulting from example 4 (FIG. 2) was collected and compared to the spectra presented in U.S. Pat. No. 6,036,935. The spectrum of the product of example 4 differs from the products presented in U.S. Pat. No. 6,036,935 and has its peak at 0.357 ppm. Additionally, this spectrum does not have a peak at 63 ppm indicating that there are no Al₁₃ polymeric species present.

Although the present invention has been described in terms of specific embodiments, the invention is not to be so limited. Various changes can be made in the processing conditions and to the compositions and portions used as would be within the scope of one skilled in the art while still obtaining the benefits of the invention. Accordingly, the invention is only to be limited by the scope of the appended claims.

What is claimed:

1. A method of producing elevated polyaluminum chloride or polyaluminum chlorosulfate comprising the steps of:
a) charging and re-circulating a mixture of from about 1.5 to about 10 parts of an aluminum reactant selected from aluminum chloride, low-basicity polyaluminum chloride, low-basicity polyaluminum chlorosulfate, mid-basicity polyaluminum chloride, mid-basicity polyaluminum chlorosulfate into a pressure reaction vessel at a pressure not less than atmospheric pressure; and
b) subjecting the aluminum reactqant to ultrasonic processing and continuing said ultrasonic processing for a period of at least 30 minutes while admixing therewith one part of sodium aluminate having a concentration of about 43%; and
c) withdrawing and filtering the reaction product to yield a stable elevated basicity solution.

2. The method of claim 1 wherein the ultrasonic processing step b) may extend for a period of from about 30 minutes to more than 12 hours.

3. The method of claim 1 wherein the reactant of step a) is aluminum chloride.

4. The method of claim 1 wherein the reactant of step a) is low-basicity polyaluminum chloride.

5. The method of claim 1 wherein the reactant of step a) is low-basicity polyaluminum chlorosulfate.

6. The method of claim 1 wherein the reactant of step a) is mid-basicity polyaluminum chloride.

7. The method of claim 1 wherein the reactant of step a) is mid-basicity polyaluminum chlorosulfate.

8. The method of claim 1 wherein the parts of aluminum reactant of step a) charged and recirculated is from about 2.5 to about 5.5 parts.

9. The method of claim 1 wherein the reactant of step a) charged and recirculated is from about 3.5 to about 4.5 high-basicity polyaluminum chlorosulfate.

10. The product produced by the method of claim 1 wherein the Al/Cl ratio of the solution product is within the range of about 0.54-0.90.

11. The product produced by the method of claim 1 wherein the solution product contains an alumina (Al₂O₃) concentration in the range of 10-13.5%.

12. The product produced by the method of claim 1 wherein the basicity of the solution product is within the range of 33-85%.

13. A continuous method for producing respectively polyaluminum chloride and polyaluminum chlorosulfate comprising the steps of
a) flowing an admixture of a reactant selected from aluminum chloride, low basicity polyaluminum chloride, low-basicity polyaluminum chlorosulfate, mid-basicity polyaluminum chloride and mid-basicity polyaluminum chlorosulfate concurrently with a co-resistant sodium aluminate solution.
b) Subjecting the mixture to ultrasonic processing treatment; and
c) Recycling the reaction product under ultrasonic processing treatment to prevent formation of undesirable precipitates

14. The method of claim 13 wherein the reactant of step a) is aluminum chloride.

15. The method of claim 13 wherein the reactant of step a) is low basicity polyaluminum chloride.

16. The method of claim 13 wherein the reactant of step a) is low-basicity polyaluminum chlorosulfate.

17. The method of claim 13 wherein the reactant of step a) is mid-basicity polyaluminum chloride.

18. The method of claim 13 wherein the reactant of step a) is mid-basicity polyaluminum chlorosulfate.

19. The product produced by the method of claim 13 wherein the Al/Cl ratio of the solution is within the range of 0.54-0.9.

20. The product produced by the method of claim 13 wherein the product solution contains an alumina (Al₂O₃) concentration in the range of 10-13.5%.

21. The product produced by the method of claim 13 wherein the basicity of the solution is within the range of 33-85%.
